(19) United States
(12) Patent Application Publication
(10) Pub. No.: US 2007/0257575 A1
(43) Pub. Date: Nov. 8, 2007

(54) Synchronous Machine Using the Thirteenth Harmonic

(75) Inventor: Rolf Vollmer, Gersfeld (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, 80333 Munchen (DE)

(21) Appl. No.: 11/575,176

(22) PCT Filed: Sep. 5, 2005
(86) PCT No.: PCT/EP05/54350

§ 371 Date: Mar. 13, 2007

(30) Foreign Application Priority Data
Sep. 15, 2004 (DE) 10 2004 044 700.4

(51) Int. Cl. H02K 3/28; H02K 21/12

(52) U.S. Cl. 310/156.38; 310/156.01

(57) ABSTRACT

A permanently-excited synchronous machine (51), comprises a stator (53) and a rotor (55), the stator (53) preferably comprising a three-phase alternating current winding and the rotor (55) permanent magnets (57). The stator (53) has 21 grooves (1-21) and the rotor (55) four magnetic poles (39). The grooves of the stator (53) are wound such that a first harmonic is suppressed by a winding pattern and a second harmonic suppressed by magnet geometry.

The invention relates to a permanent-magnet synchronous machine, and to a method for suppression of harmonics.

Permanent-magnet synchronous machines, whose rotor is excited by means of permanent magnets, have various advantages over synchronous machines with electrical excitation. For example, the rotor in a permanent-magnet synchronous machine does not require any electrical connection. Permanent magnets with a high energy density, that is to say a large product of the flux density and field strength, have been found to be superior to permanent magnets with less energy. It is also known that permanent magnets cannot only be arranged flat with respect to the air gap, but could also be positioned in a form of joint configuration (flux concentration).

Disadvantageous oscillating torques can occur in permanent-magnet synchronous machines. Skew of a rotor or of a stator in the permanent-magnet synchronous machine by, for example, one slot pitch, as is described for conventional motors in EP 0 545 060 B1, can lead to a reduction in the torque. In permanent-magnet synchronous machines with conventional winding, that is to say windings which are produced using the pulling-in technique, skew by one slot pitch is generally implemented in order to reduce cogging torques, which also lead to oscillating torques.

In permanent-magnet synchronous machines which have tooth-wound coils it is, for example, possible to reduce the oscillating torques by special shaping of the magnets. This has the disadvantage that special shaping of the magnets leads to increased production costs.

This synchronous machine also has electromotive force harmonics, depending on the winding of the stator of a three-phase permanent-magnet synchronous machine and the configuration of the rotor of this synchronous machine. These electromotive force harmonics affect the magnetic field profile in the air gap between the stator and the rotor. The electromotive force harmonics cause oscillating torques.

The invention is accordingly based on the object of specifying a permanent-magnet synchronous machine in which oscillating torques, or cogging torques, are reduced in a simple manner. This reduction is advantageously achieved without the use of any skew, for example of the permanent magnets.

The object is achieved by a method having the features as claimed in claim 1. A further solution for a permanent-magnet synchronous machine is achieved by the features as claimed in claim 3. The dependent claims 2 and 4 to 6 disclose further advantageous developments of the invention.

In a method for harmonic suppression in a permanent-magnet synchronous machine, harmonics are reduced by means of a winding configuration and by means of the magnet geometry of the permanent magnets on the rotor of the permanent-magnet synchronous machine. In this case, the permanent-magnet synchronous machine has a rotor and a stator, with the stator preferably having a three-phase winding, and the rotor having permanent magnets. The winding configuration is used to reduce the first harmonic, and the magnet geometry is used to reduce the second harmonic. The magnet geometry relates, for example, to the shape of the permanent magnets and/or to the position of the permanent magnets (for example skew of the permanent magnets), and/or to the extent of coverage of the rotor with magnetic material, that is to say with permanent magnets.

A corresponding permanent-magnet synchronous machine can be designed for a method such as this.

A permanent-magnet synchronous machine which also achieves the object according to the invention has a stator and a rotor. The stator has a three-phase winding and the rotor has permanent magnets. Furthermore, the stator has 21 teeth, and the rotor has four magnet poles.

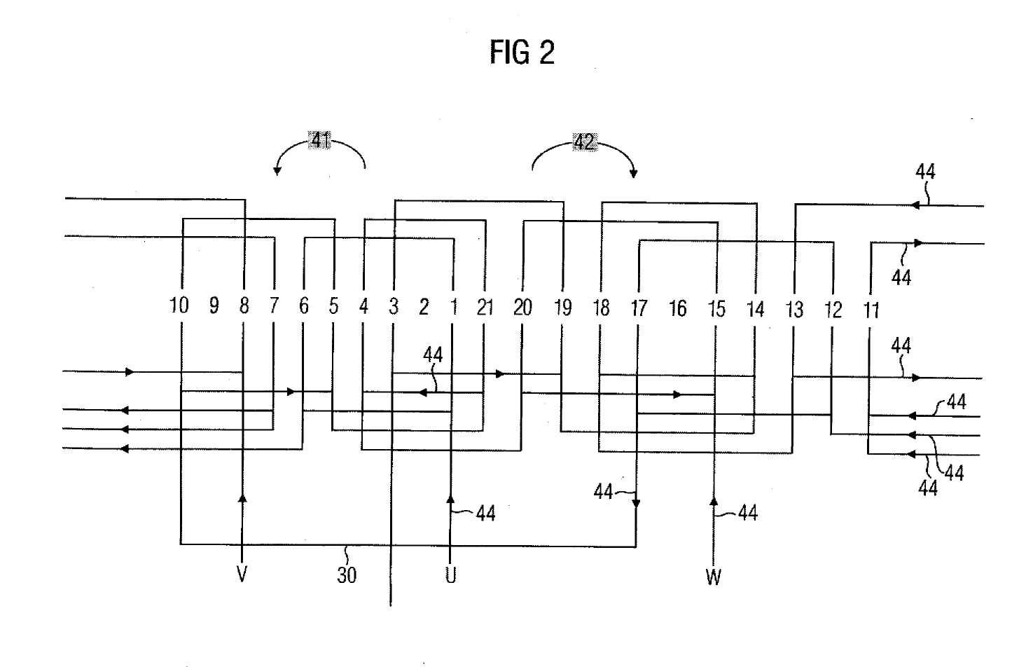

The described embodiment makes it possible for the permanent-magnet synchronous machine to advantageously have high utilization and a high power factor. This is also the situation in particular when the permanent-magnet synchronous machine has a winding configuration as shown in FIG. 2. The permanent-magnet synchronous machine according to the invention thus allows reduced cogging torque formation, with a specific combination of a number of slots in the stator and a specific number of poles on the rotor. The reduced cogging torque formation results in particular from the winding concept. The number of poles (=the number of magnet poles) on the rotor indicates the number of useful poles. According to the invention, the number of useful poles is four.

Furthermore, there is no need for any skew and/or staggering (stepped skew) for the rotor and/or for the stator in order to reduce the cogging torques in the synchronous machine according to the invention since reduced torque ripple can be achieved just by their design. The possibility to dispense with skew and/or staggering reduces the complexity for construction of the permanent-magnet synchronous machine.

A spectrum of air gap fields can be produced by the current flow through the stator winding. On analysis of this spectrum of air gap fields, a distinction can be drawn between harmonic fields and a fundamental field over the circumference of 360 degrees.

For the permanent-magnet synchronous machine according to the invention, the number of basic pole pairs is pg=1. The number of basic pole pairs pg is defined as follows: pg is the smallest number of pole pairs resulting from the Fourier analysis of the air gap field. The number of useful pole pairs pn results from the number of pole pairs on the rotor, and is a consequence 2, since the rotor has two magnet pole pairs.

This results in use of a second harmonic for the permanent-magnet synchronous machine. The fundamental and the harmonics of a field profile in an air gap in an electrical machine may, for example, be determined by means of a Fourier analysis.

In one advantageous refinement, the winding of the stator is designed in such a manner that, in particular, disturbing harmonics such as the fifth (5 pn) and seventh (7 pn) harmonic have only a small amplitude. The fifth and the seventh harmonic are particularly disadvantageous because they have opposite rotation directions and in each case lead to torque fluctuations with the sixth harmonic, at the rotor rotation speed.

The fifth and seventh harmonic of the rotor field rotate at the rotor frequency. The stator field 5 pn rotates at ⅕ of the rotor frequency in the opposite direction to the rotor, and the stator field 7 pn rotates at 1/7 of the rotor frequency in the same direction as the rotor. The stator and rotor fields at 5 pn and 7 pn oppose one another 6 pn-times per rotor revolution, and produce a torque ripple at 6 pn per rotor revolution.

In order to reduce the fifth harmonic and the seventh harmonic, the winding, particularly in the case of synchronous machines, has until now also been short-pitched, with 18 slots. In addition, short-pitching of the winding is complex, and can be avoided in the permanent-magnet synchronous machine according to the invention.

In a further advantageous refinement of the permanent-magnet synchronous machine, its stator has 21 slots, with three slots not being wound. In one advantageous refinement of the permanent-magnet synchronous machine, the three slots that are not wound are used for cooling on the permanent-magnet synchronous machine. By way of example, a cooling medium can be passed through the slots. In one embodiment, additional cooling channels are also incorporated in the slots for this purpose. The cooling medium is either gaseous or liquid. The slots which are not wound can also be provided, for example, in order to hold a heat pipe or a cool jet, or these slots have a corresponding cooling device. The three slots are advantageously distributed symmetrically in the stator.

A further embodiment of the permanent-magnet synchronous machine according to the invention is designed in such a manner that the rotor is essentially 75% to 85% covered with magnetic material. The magnetic material is essentially that of the permanent magnets. The rotor is therefore designed such that the magnetic material coverage is 75% to 85% of the pole pitch.

In a further embodiment of the permanent-magnet synchronous machine, the winding configuration of the stator is designed in such a manner that the seventh harmonic tends virtually to zero, that is to say it is greatly reduced. With a winding configuration such as this, the stator has 21 slots, which are numbered from 1 to 21. The slots are wound for three-phase current flow, with a phase U, a phase V and a phase W. The winding coils have a first winding direction and a second winding direction, with:
a) the slots 1, 6, 7, 11, 12 and 17 being filled with the phase U, with a first coil for the phase U in the slots 1 and 6 being formed in the first winding direction, a second coil for the phase U in the slots 7 and 11 being formed in the second winding direction, and a third coil for the phase U in the slots 12 and 17 being formed in the first winding direction, and
b) the slots 8, 13, 14, 18, 19 and 3 being filled by means of the phase V, with a first coil for the phase V in the slots 8 and 13 being formed in the first winding direction, a second coil for the phase V in the slots 14 and 18 being formed in the second winding direction, and a third coil for the phase V in the slots 19 and 3 being formed in the first winding direction, and
c) the slots 15, 20, 21, 4, 5 and 10 being filled by means of the phase W, with a first coil for the phase W in the slots 15 and 20 being formed in the first winding direction, a second coil for the phase W in the slots 21 and 4 being formed in the second winding direction, and a third coil for the phase W in the slots 5 and 10 being formed in the first winding direction.

The slots 2, 9 and 16 are not filled with a winding—that is to say they are unoccupied—and may, for example, be used for cooling of the permanent-magnet synchronous machine.

Since the permanent magnets on the rotor or else the slots in the stator no longer need to be skewed, this results in a large number of advantages, such as:
there is no utilization loss resulting from the skew factor,
expensive skewed permanent magnets can be replaced by low-cost straight permanent magnets,
if the slots in the stator would have had to be skewed according to the prior art, lower-cost and/or faster manufacturing methods can now be used for forming the slots and for winding,
without any skew, the manufacturing facilities for fitting permanent magnets to the rotor and/or for magnetization of magnetic raw material can be simplified,
manufacturing can be automated more easily,
it is easier to wind the slots in the stator, since three slots are not wound,
sensors (for example temperature sensors) which, for example, measure the temperature can be positioned in the slots which are not wound.

In the case of the permanent-magnet synchronous machine according to the invention, in order to further improve the harmonic behavior and to additionally improve the torque ripple, measures such as skewing of the permanent magnets on the rotor and/or skewing of the windings in the stator and/or corresponding staggering and/or short-pitching of the windings can additionally be carried out. The additional use of these means can also be used to improve the permanent-magnet synchronous machine since these measures can be used to reduce further undesirable harmonics. For example, each individual method can thus be used to reduce a different harmonic, and to improve the harmonic behavior.

Furthermore, the permanent-magnet synchronous machine can be designed such that the hole number is q=7/4. The hole number q indicates over how many slots per pole the winding of a winding section is split, that is to say q is the number of slots per pole and winding section. This value for the hole number is actually of major importance in order to ensure that the least common multiple of the number of poles and the number of slots is very high.

In order to keep cogging torques of permanent magnets on the rotor with stator teeth low, the number of slots and the number of poles can be chosen such that the least common multiple is as high as possible. This is achieved by the number of pole pairs (the number of useful pole pairs) being of prime number. The number of useful pole pairs is therefore a prime number.

In a further refinement of the permanent-magnet synchronous machine, the edge areas of the permanent magnets are lowered in such a manner that this results in a larger air gap over the edges of the permanent magnets.

The combination of a plurality of measures, such as the selection of the number of poles and the selection of the number of slots which together produce little cogging (cogging torque) and the use of a specific winding configuration for suppression of the seventh harmonic, are advantageous features of the invention. Furthermore, the fifth harmonic can be suppressed by selection of an advantageous magnet geometry and/or magnet width. The fifth harmonic is suppressed not only, for example, by eighty percent pole coverage but also by means of an advantageous magnet contour. The magnet geometry affects, in particular, the coverage of the poles of the rotor with magnetic material. The winding configuration and/or the magnet geometry can also be modified so as to make it possible to suppress other harmonics than those quoted by way of example, by the modification.

The invention as well as advantageous refinements of the invention will be explained in more detail, by way of example, with reference to the drawing, in which:

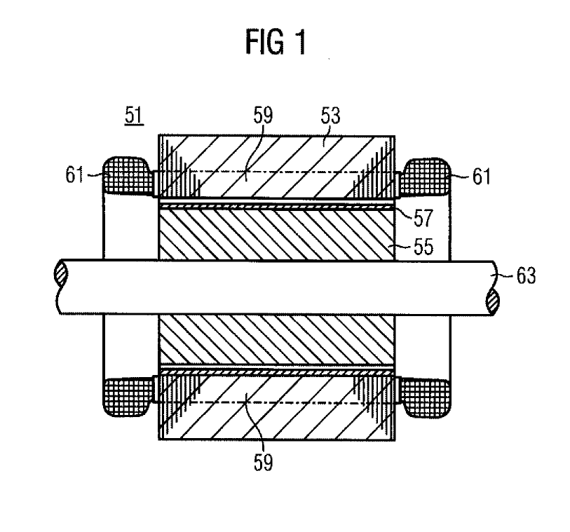

FIG. 1 shows, schematically, the design of a permanent-magnet synchronous machine,

FIG. 2 shows a winding diagram,

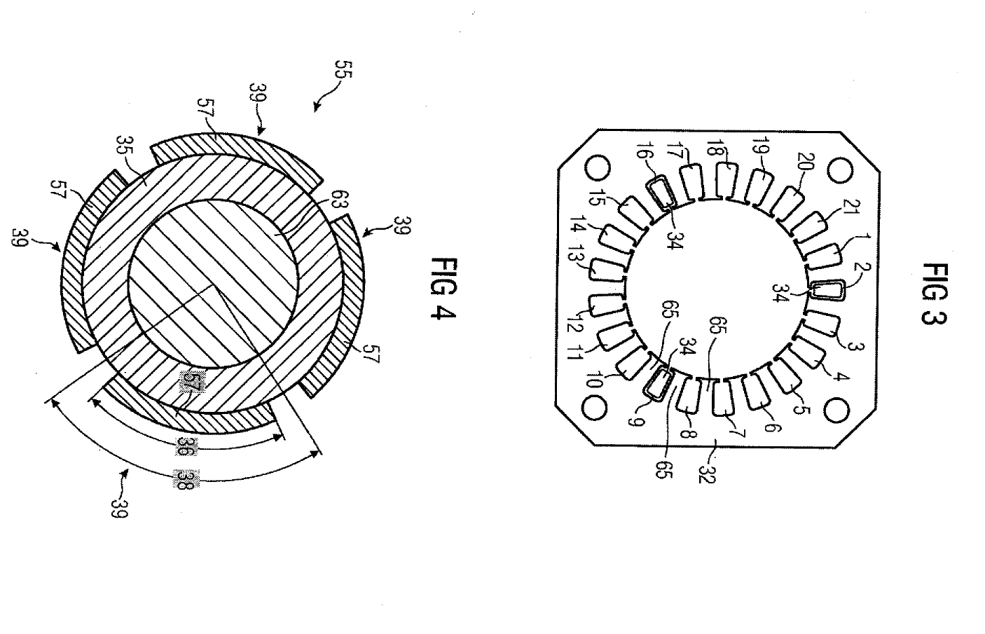

FIG. 3 shows a laminate section for a stator which has 21 slots, with three slots not being wound, and

FIG. 4 shows magnet coverage of the pole pitch.

The illustration in FIG. 1 shows a permanent-magnet synchronous machine 51 which has a stator 3 and a rotor 5. The rotor 55 has permanent magnets 57. The stator has coils 59, with the profile of the coil 59 being shown by dashed lines within the laminated stator 53. The coil 59 forms a winding. The coils 59 form end windings 61. The permanent-magnet synchronous machine 1 is intended to drive a shaft 63.

The illustration in FIG. 2 shows a winding diagram relating to a permanent-magnet synchronous machine through which three-phase current, with three phases U, V, W, can flow. The winding diagram for the stator of the permanent-magnet synchronous machine relates to a stator which has 21 slots. The 21 slots are annotated 1 to 21. The associated rotor, which is not illustrated in FIG. 2, has four poles (magnet poles), that is to say two pole pairs. According to the winding diagram shown in FIG. 2, the stator has nine coils, with each of the phases U, V and W in FIG. 2 having three coils. The winding shown in FIG. 2 has a star point 30. Star connection is particularly advantageous when the third harmonic is not eliminated. In a situation in which the third harmonic is not important, the winding diagram can be modified in such a manner that this results in delta connection, although this is not shown. Coils are formed by the windings in the slots 1 to 21. The coils have different winding directions 44, with arrows being used to illustrate the winding directions 44. A first winding direction 41 and a second winding direction 42 are indicated in FIG. 2.

The slots 1, 6, 7, 11, 12 and 17 are filled (wound) for the phase U, with a first coil for the phase U in the slots 1 and 6 being formed in the first winding direction 41, a second coil for the phase U in the slots 7 and 11 being formed in the second winding direction 42, and a third coil for the phase U in the slots 12 and 17 being formed in the first winding direction.

The slots 8, 13, 14, 18, 19 and 3 being filled (wound) for the phase V, with a first coil for the phase V in the slots 8 and 13 being formed in the first winding direction 41, a second coil for the phase V in the slots 14 and 18 being formed in the second winding direction 42, and a third coil for the phase V in the slots 19 and 3 being formed in the first winding direction 41.

The slots 15, 20, 21, 4, 5 and 10 are filled (wound) for the phase W, with a first coil for the phase W in the slots 15 and 20 being formed in the first winding direction 41, a second coil for the phase W in the slots 21 and 4 being formed in the second winding direction 42, and a third coil for the phase W in the slots 5 and 10 being formed in the first winding direction 41.

Slots 2, 9 and 16 are not filled with any winding.

The illustration in FIG. 3 shows a laminate section 32 for a stator which has 21 slots 1 to 21, and likewise has a large number of teeth 65. The slots 2, 9 and 16 are intended to hold a cooling channel 34.

The illustration in FIG. 4 shows a cross section through the rotor 55. This illustration also shows magnet coverage 36 with a pole pitch 38. The rotor 55 has four poles 39. The poles 39 are formed by permanent magnets 57. The permanent magnets 57 are fitted on a mount 35. The mount is located on the shaft 63. In the illustration in FIG. 4, the magnet coverage 36 for each of the four poles is approximately 80% of the pole pitch 38.

A permanent-magnet synchronous machine which is designed as shown in FIGS. 2 to 4 has, in particular, the following winding factors:

| P | Winding factor | |
|---|---|---|
| ξs | | |
| 0 | 0 | |
| 1 | 0.222 | [symbol] Basic number of pole pairs |
| 2 | 0.968 | [symbol] Useful number of pole pairs |
| 3 | 0.209 | |
| 4 | 0.132 | |
| 5 | 0.088 | |
| 6 | 0.73 | |
| 7 | 5.818 · 10⁻⁶ | |
| 8 | 0.17 | |
| 9 | 0.08 | |
| 10 | 0.357 | [symbol] Fifth harmonic |
| 11 | 0.357 | |
| 12 | 0.08 | |
| 13 | 0.17 | |
| 14 | 1.164 · 10⁻⁵ | [symbol] Seventh harmonic |
| 15 | 0.73 | |

In this case, the first column shows the number of pole pairs p, and the second column the winding factor. The winding factor is calculated as follows:

$$ξ {s}_{p} := \vert \frac{{\sum }_{i = 0}^{k} ( {a}_{i} \cdot {ⅇ}^{j \cdot {ϕ}_{i , p}} )}{{\sum }_{i = 0}^{k} {a}_{i}} \vert$$

k+1 indicates the number of occupied slots for one phase. The winding factor is the quotient of the sum of the vectorially added phase voltages, and the sum of the magnitudes of the phase voltages.

The vector aᵢ indicates the amplitudes of the voltage vectors of the phase voltages.

The vector Φᵢ indicates the angle of the voltage vectors, in this case with the vector wᵢ indicating whether this is a forward conductor or a return conductor.
Amplitude:

$$a := ( \begin{matrix}1 \\ 1 \\ 1 \\ 1 \\ 1 \\ 1\end{matrix} )$$

Slot angle mechanical

$$α := ( \begin{matrix}0 \\ 17.143 \\ 102.857 \\ 188.571 \\ 274.286 \\ 291.428\end{matrix} )$$

$$\begin{matrix}{ϕ}_{i , p} := ( {α}_{i \cdot p \cdot } \frac{π}{180} ) + {w}_{i} & wi = ( \begin{matrix}0 \\ 0 \\ π \\ 0 \\ π \\ π\end{matrix} ) r = 0\end{matrix} ,$$

Return conductor=□
In which case:
k:=5
j:=\sqrt{1}
p:=1 . . . 15

1-6. (canceled)

7. A method for harmonic suppression in a permanent-magnet synchronous machine including a stator having a winding and slots, and a rotor having permanent magnets, said rotor interacting with said stator, said method comprising the steps of:
suppressing a first given harmonic using a configuration of the winding, and
suppressing a second given harmonic using a magnet geometry relating to magnet width or pole coverage, or both.

8. The method of claim 7, wherein the magnet geometry has four magnet poles.

9. The method of claim 7, wherein the winding configuration is a three phase winding configuration.

10. The method of claim 7, wherein the winding configuration has 21 slots.

11. The method of claim 7, wherein the winding configuration has three slots that are not wound.

12. The method of claim 7, wherein the magnet geometry has magnetic material coverage that is substantially 75% to 85% of the pole pitch of the rotor.

13. The method of claim 7, wherein the winding configuration has a three-phase winding and 21 slots, sequentially numbered from 1 to 21, respective coils in said slots having a first winding direction and a second winding direction,
a) for the first phase a first coil is wound in slots 1 and 6 in the first winding direction, a second coil is wound in slots 7 and 11 in the second winding direction, and a third coil is wound in slots 12 and 17 in the first winding direction,
b) for the second phase a first coil is wound in slots 8 and 13 in the first winding direction, a second coil is wound in slots 14 and 18 in the second winding direction, and a third coil is wound in slots 19 and 3 in the first winding direction,
c) for the third phase a first coil is wound in slots 15 and 20 in the first winding direction, a second coil is wound in slots 21 and 4 in the second winding direction, and a third coil is wound in slots 5 and 10 in the first winding direction, and
d) slots 2, 9 and 16 not having a coil.

14. The method of claim 11, wherein said three slots in the winding configuration are distributed symmetrically.

15. The method of claim 11, further comprising the step of providing temperature means in said three slots.

16. The method of claim 7, wherein the winding configuration and magnet geometry provide a hole number q=7/4.

17. The method of claim 7, further comprising the step of wherein the magnet geometry includes edge areas on the permanent-magnets and an air gap over the edges of the permanent magnets, the edges of the permanent magnets being lowered so that the air gap is increased.

18. A permanent-magnet synchronous machine, comprising:
a stator having 21 slots and a three-phase winding; and
a rotor having permanent magnets interacting with said stator, said rotor having four magnet poles.

19. The permanent-magnet synchronous machine of claim 18, wherein three slots are not wound.

20. The permanent-magnet synchronous machine of claim 18, wherein said rotor is essentially 75% to 85% covered with magnetic material.

21. The permanent-magnet synchronous machine of claim 18, wherein said stator has a three-phase winding, with the 21 slots sequentially numbered from 1 to 21, and with respective coils in said slots having a first winding direction and a second winding direction,
a) for the first phase a first coil is wound in slots 1 and 6 in the first winding direction, a second coil is wound in slots 7 and 11 in the second winding direction, and a third coil is wound in slots 12 and 17 in the first winding direction,
b) for the second phase a first coil is wound in slots 8 and 13 in the first winding direction, a second coil is wound in slots 14 and 18 in the second winding direction, and a third coil is wound in slots 19 and 3 in the first winding direction,
c) for the third phase a first coil is wound in slots 15 and 20 in the first winding direction, a second coil is wound in slots 21 and 4 in the second winding direction, and a third coil is wound in slots 5 and 10 in the first winding direction, and
d) slots 2, 9 and 16 not having a coil.

22. The permanent-magnet synchronous machine of claim 19, wherein said three slots are distributed symmetrically in said stator.

23. The permanent-magnet synchronous machine of claim 19, wherein said three slots hold temperature means.

24. The permanent-magnet synchronous machine of claim 18, further comprising a hole number q=7/4.

25. The permanent-magnet synchronous machine of claim 18, further including edge areas on said permanent-magnets and an air gap over said edges of the permanent magnets, said edges on the permanent magnets being lowered so that said air gap is increased.

26. A permanent-magnet synchronous machine, comprising:
a stator having slots and a winding having a winding configuration, said winding configuration providing said winding in selected slots so that some slots have a winding and fewer slots have no winding, said winding being configured for suppressing a first given harmonic; and
a rotor having permanent magnets, said rotor interacting with said stator, said rotor having a magnet geometry adapted to suppress a second given harmonic, said magnet geometry relating to magnet width or pole coverage or both.

27. The permanent-magnet synchronous machine of claim 26, wherein said permanent magnets provide two useful magnetic pole pairs so that the second harmonic of the field is used by the synchronous machine, said magnet geometry suppresses the fifth harmonic and said winding configuration suppresses the seventh harmonic.
